(19) United States
(12) Patent Application Publication
(10) Pub. No.: US 2026/0027590 A1
(43) Pub. Date: Jan. 29, 2026

(54) SPONGE BLOCK HAVING OUTER COVER REPLACEMENT FUNCTION

(71) Applicant: MSFORYOU CO., LTD., Seoul (KR)

(72) Inventor: Cheon Hoo PARK, Gyeonggi-do (KR)

(21) Appl. No.: 18/996,020

(22) PCT Filed: Nov. 18, 2022
(86) PCT No.: PCT/KR2022/018325

§ 371 Date: Jan. 17, 2025

(30) Foreign Application Priority Data
Jul. 26, 2022 (KR) 10-2022-0092564

(51) Int. Cl. B08B 1/14; B60S 3/04

(52) U.S. Cl. CPC B08B 1/143; B60S 3/045

(57) ABSTRACT

A sponge block having an outer cover replacement function includes: a sponge layer; and an outer cover that is coupled to cover all surfaces of the sponge layer except for the front and rear surfaces thereof and is replaceable depending on a use purpose, the outer cover having a waterproof layer on the inner surface thereof. The outer cover covering all surfaces of the sponge layer except for the front and rear surfaces thereof is replaceable depending on a use purpose, and thus can be used for a long time through dedicated use, the outer cover is easy to manufacture, resulting in low production costs, a waterproof layer is provided on the inner surface of the outer cover to prevent expensive polish or a coating solution from penetrating into the sponge layer.

### TECHNICAL FIELD

The present invention relates to a sponge block having an outer cover replacement function, and more particularly to a sponge block capable of replacing an outer cover to suit a purpose of use, such as coating, cleaning, or polishing the surface of an automobile.

### BACKGROUND ART

In general, the painted surface of an automobile may be damaged by extreme cold, extreme heat, rain, wind, snow, etc., as it comes into direct contact with outdoor air, or when the painted surface is exposed to ultraviolet light for a long time, the gloss or water repellency of the painted surface may be reduced and the painted surface may be discolored.

In order to prevent reduction in the gloss and water repellency of the painted surface and delay discoloration thereof, a polishing process is performed on the outer surface of the automobile.

In a general car polishing process, a polish having gloss and water repellency is applied to a target automobile and dried to form a glossy surface on the painted surface of the automobile so as to improve the gloss and water repellency of the painted surface while preventing penetration of ultraviolet light so as to prevent discoloration. However, because a soft glossy film is provided as the polish in a liquid state with gloss and water repellency on the painted surface is dried, only the gloss and water repellency of the painted surface are simply improved without changing the strength of the painted surface, and thus, the painted surface may be quickly peeled off depending on the external environment, thereby having a short lifespan.

A technology related to a block used to polish the outer surface of an automobile has been proposed in Korean Patent Registration No. 2192898.

However, in the technology disclosed in Patent Document 1, a lot of time was required to fix a microfiber fabric to the coating block, and a coating solution or the like melted an adhesive used to bond a sponge part to a main block and thus the replacement cycle of the sponge part was shortened.

(Patent document 1) Korean Patent Registration No. 2192898 (Dec. 14, 2020)

### Technical Problem

Therefore, the present invention has been made in view of the above problems, and it is an object of the present invention to provide a sponge block having an outer cover replacement function that enables an outer cover to be replaced and used depending on a purpose of use selected from among coating, polishing, and cleaning.

### Technical Solution

In accordance with the present invention, the above and other objects can be accomplished by the provision of a sponge block having an outer cover replacement function including a sponge layer, and an outer cover coupled to cover remaining surfaces of the sponge layer except for front and rear surfaces thereof, configured to be replaceable depending on a purpose of use, and provided with a waterproof layer on an inner surface of the outer cover.

Longitudinal guides formed of a synthetic resin may be fixed at predetermined intervals on an inner surface of the outer cover.

Longitudinal guides formed of an elastic material may be fixed at predetermined intervals on the inner surface of the outer cover.

If the guides are formed of the synthetic resin, grooves may be formed on an outer surface of the sponge layer at positions corresponding to the guides.

Upper and lower parts of the sponge layer may have the same hardness or different hardnesses.

The outer cover may be provided with at least one of a suede fabric or a microfiber fabric.

### Advantageous Effects

According to the present invention, an outer cover that covers the remaining surfaces of a sponge layer except for the front and rear surfaces thereof is replaceable depending on a purpose of use and is thus usable for a long time due to dedicated use thereof, and is easy to manufacture, resulting in low production costs, a waterproof layer is provided on the inner surface of the outer cover to prevent an expensive polish or coating solution from penetrating into the sponge layer so as to prevent waste of the polish or the coating solution, and the outer cover may be easily inserted into the sponge layer by guides.

### BRIEF DESCRIPTION OF DRAWINGS

FIG. 1 is an exploded perspective view showing a sponge block having an outer cover replacement function according to the present invention.

FIG. 2 is a cross-sectional view showing the sponge block having the outer cover replacement function according to the present invention.

FIG. 3 a longitudinal-sectional view showing one example of a sponge layer in the sponge block having the outer cover replacement function according to the present invention.

FIG. 4 is a front view showing embodiments of an outer cover in the sponge block having the outer cover replacement function according to the present invention.

FIGS. 5 and 6 are cross-sectional views showing states in which guides are provided on the inner surface of the outer cover in the sponge block having the outer cover replacement function according to the present invention.

### DETAILED DESCRIPTION OF THE INVENTION

The above and other objects, features and other advantages of the present invention will become more apparent from the following detailed description of exemplary embodiments of the present invention. Hereinafter, a sponge block having an outer cover replacement function according to one embodiment of the present invention will be described in detail with reference to the accompanying drawings.

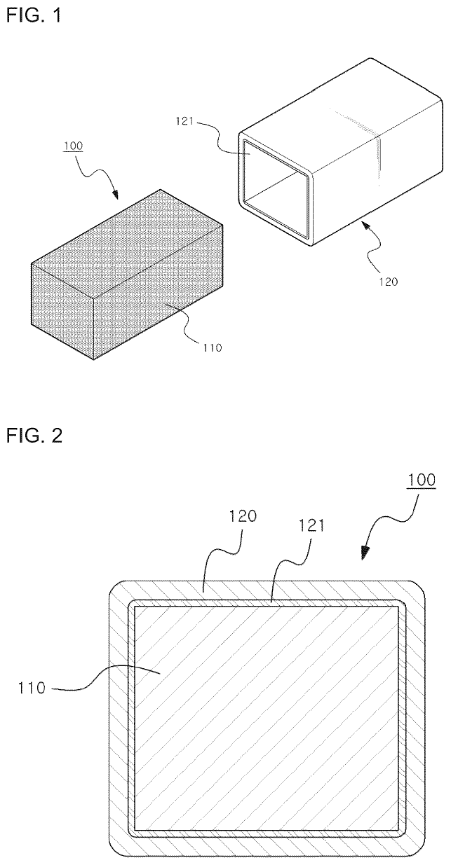

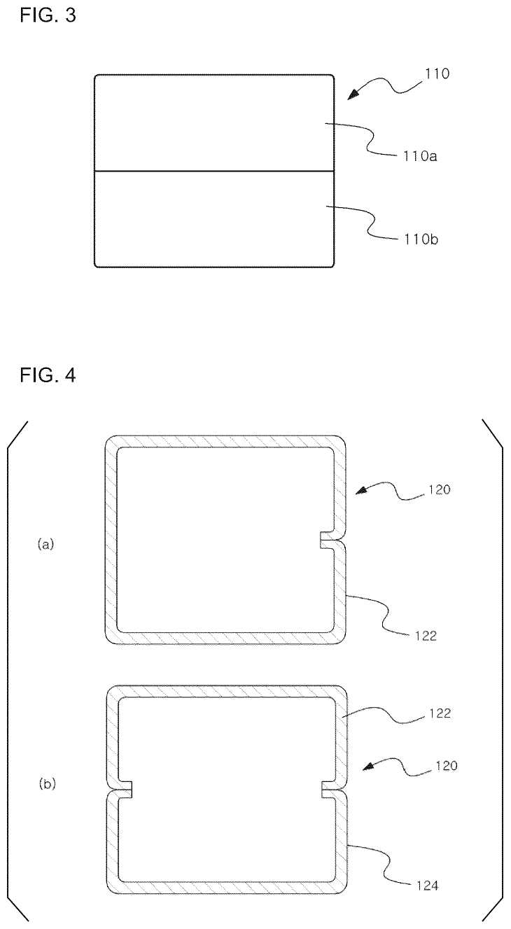

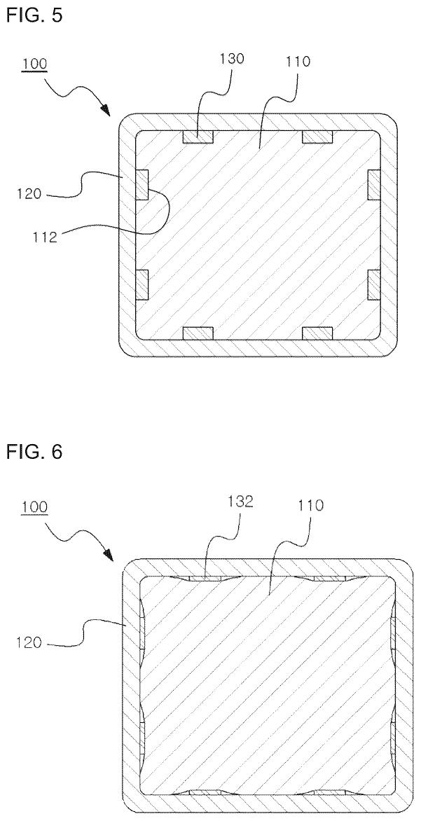

FIG. 1 is an exploded perspective view showing a sponge block having an outer cover replacement function according to the present invention, FIG. 2 is a cross-sectional view showing the sponge block having the outer cover replacement function according to the present invention, FIG. 3 a longitudinal-sectional view showing one example of a sponge layer in the sponge block having the outer cover replacement function according to the present invention, FIG. 4 is a front view showing embodiments of an outer cover in the sponge block having the outer cover replacement function according to the present invention, and FIGS. 5 and 6 are cross-sectional views showing states in which guides are provided on the inner surface of the outer cover in the sponge block having the outer cover replacement function according to the present invention.

Referring to FIGS. 1 to 6, a sponge block 100 having an outer cover replacement function according to one embodiment of the present invention includes a sponge layer 110 and an outer cover 120.

The sponge layer 110, as shown in FIGS. 1 to 3, 5, and 6, is formed in a hexahedral shape while being formed of a material, such as EVA foam or polyurethane, and is prevented from being deformed when a user grips the sponge layer 110.

Furthermore, the sponge layer 110 has the same hardness at the upper and lower parts thereof, or different hardnesses at the upper and lower parts thereof, as shown in FIG. 2. In this case, the sponge layer 110 is formed of a soft layer 110a having low hardness, or a hard layer 110b having high hardness. Alternatively, one part of the sponge layer 110 may be formed of the soft layer 110a and the other part may be formed of the hard layer 110b.

Here, the soft layer 110a may be used for coating, and the hard layer 110b may be used for polishing.

The outer cover 120 is coupled to cover the remaining surfaces of the sponge layer 110 except for the front and rear surfaces thereof, is replaceable depending on a purpose of use, and is provided with a waterproof layer 121 on the inner surface of the outer cover 120, as shown in FIGS. 1, 2, and 4 to 6.

Here, the waterproof layer 121 is formed on the inner surface of the outer cover 120 by a method, such as coating or adhesion, so as to prevent a coating solution, etc., from penetrating into the sponge layer 110.

Furthermore, the waterproof layer 121 may be easily coupled to the sponge layer 110 because it has less friction with the surface of the sponge layer 110 when replacing the outer cover on the sponge layer 110.

Furthermore, the outer cover 120 may be provided with at least one of a suede fabric 122 or a microfiber fabric 124. That is, if the outer cover 120 is provided with either the suede fabric 122 or the microfiber fabric 124, as shown in FIG. 4(a), a sewing line is formed at neighboring ends of the fabric, and thus production costs are reduced due to ease of production. The outer cover 120 is illustrated as being provided with the suede fabric 122 and the microfiber fabric 124, but is not limited thereto and may be provided with other various fabrics. In addition, if one part of the outer cover 120 is provided with the suede fabric 122 and the other part of the outer cover 120 is provided with the microfiber fabric 120, a sewing line is formed at each of both sides of the fabrics.

Referring to FIGS. 5 and 6, the outer cover 120 is provided with longitudinal guides 130 or 132 at predetermined intervals on the inner surface thereof. Here, although not shown in the drawings, protrusions having a right triangular cross-section may be continuously formed on the surfaces of the guides 130. In this case, when the outer cover 120 is coupled to the sponge layer 110, the inclined surfaces of the protrusions are inserted into the sponge layer 110 while touching the surface of the sponge layer 110, and conversely, when the outer skin 120 is removed, the vertical surfaces of the protrusions may touch the surface of the sponge layer 110 so that the outer cover 120 is not easily removed.

The guides 130 are formed in a longitudinal bar shape formed of a synthetic resin, and support the outer cover 120 so that the outer cover 120 does not sag when coupling the outer cover 120 to the sponge layer 120.

Here, if the guides 130 are formed of a synthetic resin, grooves 112 are formed on the outer surface of the sponge layer 110 at positions corresponding to the guides 130.

That is, the grooves 112 serve to prevent the guides 130 from interfering with coupling to the sponge layer 110 when the outer cover 120 is coupled to the sponge layer 110.

Unlike this, the guides 132 may be formed in a longitudinal band shape formed of an elastic material, such as rubber, so that the outer cover 120 may be easily coupled to the sponge layer 110 due to elasticity of the guides 132.

In this way, the sponge block 100 having the outer cover replacement function of the present invention may be efficiently used by replacing the corresponding outer cover 120 on the sponge layer 110 so as to suit a purpose of use, such as coating, cleaning, or the like.

Further, the sponge layer 110 may have the same hardness at the upper and lower parts thereof, or different hardnesses at the upper and lower parts thereof, and may be used for a purpose, such as coating or polishing, depending on the hardness.

In addition, the waterproof layer 121 provided on the inner surface of the outer cover 120 so as to facilitate coupling of the outer cover 120 to the sponge layer 110 when the outer cover 120 is coupled to the sponge layer 110 may prevent a coating liquid, etc. from penetrating into the sponge layer 110, and enable a new outer cover 120 to be easily coupled to the sponge layer 110 when replacing the the outer cover 120 on the sponge layer 110.

In addition, the outer cover 120 may be easily coupled to the sponge layer 110 through the guides 130 or 132 in addition to the waterproof layer 121.

That is, the guides 130 formed of a synthetic resin may be provided on the inner surface of the outer cover 120, and the grooves 112 may be formed on the outer surface of the sponge layer 110 at positions corresponding to the guides 130, so as to prevent the outer cover 120 from sagging when the outer cover 120 is coupled to the sponge layer 110. Alternatively, the guides 132 formed of an elastic material, such as rubber, may be provided on the inner surface of the outer cover 120 so as to easily couple the outer cover 120 to the sponge layer 110 due to elasticity of the guides 132.

Although the embodiments of the present invention have been described above with reference to the accompanying drawings, it will be understood by those skilled in the art to which the present invention pertains that the present invention may be implemented in other specific forms without changing the technical idea or essential features thereof. Therefore, it should be understood that the above-described embodiments are exemplary only in all aspects and are not intended to be limiting.

### DESCRIPTION OF REFERENCE NUMERALS AND MARKS

100: Sponge block having outer cover replacement function
110: Sponge layer
112: Groove
120: Outer cover
121: Waterproof layer
130, 132: Guide

1. A sponge block having an outer cover replacement function comprising:
a sponge layer; and
an outer cover coupled to cover remaining surfaces of the sponge layer except for front and rear surfaces thereof, configured to be replaceable depending on a purpose of use, and provided with a waterproof layer on an inner surface of the outer cover.

2. The sponge block according to claim 1, wherein longitudinal guides formed of a synthetic resin are fixed at predetermined intervals on an inner surface of the outer cover.

3. The sponge block according to claim 1, wherein longitudinal guides formed of an elastic material are fixed at predetermined intervals on an inner surface of the outer cover.

4. The sponge block according to claim 2, wherein, if the guides are formed of the synthetic resin, grooves are formed on an outer surface of the sponge layer at positions corresponding to the guides.

5. The sponge block according to claim 1, wherein upper and lower parts of the sponge layer have the same hardness or different hardnesses.

6. The sponge block according to claim 1, wherein the outer cover is provided with at least one of a suede fabric or a microfiber fabric.
